(19) United States
(12) Patent Application Publication
(10) Pub. No.: US 2022/0311849 A1
(43) Pub. Date: Sep. 29, 2022

(54) SHELL ASSEMBLY AND ELECTRONIC DEVICE

(71) Applicant: GUANGDONG OPPO MOBILE TELECOMMUNICATIONS CORP., LTD., Dongguan (CN)

(72) Inventor: Yuhu JIA, Dongguan, Guangdong (CN)

(21) Appl. No.: 17/841,631

(22) Filed: Jun. 15, 2022

Related U.S. Application Data
(63) Continuation of application No. PCT/CN2020/138964, filed on Dec. 24, 2020.

(30) Foreign Application Priority Data
Dec. 24, 2019 (CN) 201911348628.X

(51) Int. Cl. H04M 1/02; G06F 1/16

(52) U.S. Cl. CPC H04M 1/0268; G06F 1/1652; G06F 1/1675; G06F 2203/04102

(57) ABSTRACT

Provided in embodiments of the present disclosure are a shell assembly and an electronic device. The electronic device includes a first shell, a second shell movably connected to the first shell, a driving mechanism, and a flexible screen assembly. The flexible screen assembly includes a first end and a second end. The first end of the flexible screen assembly is connected to the first shell, and the second end of the flexible screen assembly is coupled to the driving mechanism. The driving mechanism is configured to drive the second shell to move relative to the first shell, to enable the electronic device to vary between an extended state and a retracted state, and is further configured to drive the flexible screen assembly to move when the electronic device changes from the extended state to the retracted state.

### CROSS-REFERENCE TO RELATED APPLICATIONS

The present application is a continuation of International Patent Application No. PCT/CN2020/138964, filed on Dec. 24, 2020, which claims priority to Chinese Patent Application No. 201911348628.X, filed on Dec. 24, 2019, the entire disclosures of which are incorporated herein by reference.

### FIELD

The present disclosure relates to the field of electronics, and in particular to a shell assembly and an electronic device.

### BACKGROUND

Generally, electronic devices such as smart-phones are equipped with a display screen. The electronic device displays images through the display screen for the user's convenience. However, the electronic devices in the related art have limited space to install the display screen, thus limiting the display area of the display screen.

### SUMMARY

Provided in an aspect of the present disclosure is an electronic device, including: a first shell; a second shell movably connected to the first shell; a driving mechanism; a flexible screen assembly; and a second driving device. The flexible screen assembly includes a first end and a second end. The first end of the flexible screen assembly is connected to the first shell, and the second end of the flexible screen assembly is coupled to the driving mechanism. The driving mechanism is configured to drive the second shell to move relative to the first shell, to enable the electronic device to vary between an extended state and an retracted state. The driving mechanism is further configured to drive the flexible screen assembly to move, when the electronic device changes from the extended state to the retracted state.

Provided in another aspect of the present disclosure is a shell assembly configured to retract and unfold a flexible screen assembly, including: a first shell; a second shell movably connected to the first shell; a first driving device; and a second driving device. The first shell is connected to a first end of the flexible screen assembly, and includes a carrier plate, a first side and a first rear cover connected together to define an accommodation cavity with an opening. The first driving device is configured to drive the second shell to move relative to the first shell in a first direction, so that the second shell moves outside the accommodation cavity or is accommodated within the accommodation cavity through the opening. The second driving device is coupled to a second end of the flexible screen assembly, and is configured to drive the flexible screen assembly to move.

Provided in a further aspect of the present disclosure is an electronic device, including a first shell, a second shell movably connected to the first shell, a driving device, and a flexible screen assembly. A first end of the flexible screen assembly is connected to the first shell, and a second end of the flexible screen assembly is coupled to the driving device. The driving device includes a motor, a transmission assembly connected to the motor, and a push assembly connected to the transmission assembly and the second shell. The motor is configured to drive the transmission assembly to move, so that the push mechanism moves along with the transmission assembly, driving the second shell to move in a first direction relative to the first shell, and driving the flexible screen assembly to move.

### BRIEF DESCRIPTION OF THE DRAWINGS

In order to illustrate the present disclosure more clearly, a brief introduction to the accompanying drawings for describing some embodiments is provided. Those of ordinary skill in the art may obtain other drawings based on the accompanying drawings described below without creative effort.

FIG. 1 is a first schematic structural diagram of the electronic device provided in the embodiments of the present disclosure;

FIG. 2 is a schematic structural diagram of the first shell in the electronic device shown in FIG. 1;

FIG. 3 is a schematic structural diagram of the second shell in the electronic device shown in FIG. 1;

FIG. 4 is a second schematic structural diagram of the electronic device provided in the embodiments of the present disclosure;

FIG. 5 is a third schematic structural diagram of the electronic device provided in the embodiments of the present disclosure;

FIG. 6 is a schematic structural diagram of the first driving device in the electronic device shown in FIG. 5;

FIG. 7 is a schematic structural diagram of the connecting member in the first driving device shown in FIG. 6;

FIG. 8 is a fourth schematic structural diagram of the electronic device provided in the embodiments of the present disclosure;

FIG. 9 is a schematic structural diagram of the first driving device in the electronic device shown in FIG. 8;

FIG. 10 is a fifth schematic structural diagram of the electronic device provided in the embodiments of the present disclosure;

FIG. 11 is a sixth schematic structural diagram of the electronic device provided in the embodiments of the present disclosure;

FIG. 12 is a seventh schematic structural diagram of the electronic device provided in the embodiments of the present disclosure;

FIG. 13 is a schematic structural diagram of the first driving device in the electronic device shown in FIG. 12;

FIG. 14 is a schematic structural diagram of the push assembly in the first driving device shown in FIG. 12.

### DETAILED DESCRIPTION OF THE PREFERRED EMBODIMENTS

Technical solutions in the embodiments of the present disclosure will be clearly and completely described below in conjunction with the accompanying drawings in the present disclosure. Obviously, the described embodiments are only part of the embodiments of the present disclosure, but not all of them. All other embodiments obtained by a person skilled in the art without creative effect based on the embodiments of the present disclosure fall within the scope of protection of the present disclosure.

Provided in an aspect of the present disclosure is an electronic device, which includes: a first shell; a second shell movably connected to the first shell; a driving mechanism configured to drive the second shell to move relative to the first shell to enable the electronic device to vary between an extended state and an retracted state; a flexible screen assembly including a first end connected to the first shell and a second end coupled to the driving mechanism. The driving mechanism is further configured to drive the flexible screen assembly to move, when the electronic device changes from the extended state to the retracted state.

In an embodiment, the driving mechanism includes a first driving device and a second driving device. The first driving device is configured to drive the second shell to move relative to the first shell along a first direction, and the second driving device is configured to drive the flexible screen assembly to move.

In an embodiment, the electronic device includes a processor, which is configured to control the first driving device at a first timing to drive the second shell to move away from the first shell, and control the second driving device at a second timing to drive the flexible screen assembly to move, when the electronic device changes from the retracted state to the extended state, so that part of the flexible screen assembly is unfolded outside the first shell, where the first timing is earlier than the second timing.

In an embodiment, the processor is further configured to control the second driving device at a third timing to drive the flexible screen assembly to move, and to control the first driving device at a fourth timing to drive the second shell to move towards the first shell, when the electronic device changes from the extended state to the retracted state, so that part of the flexible screen assembly is retracted within the first shell, where the third timing is earlier than the fourth timing.

In an embodiment, the first driving device and the second driving device are provided at the first shell. The second shell includes a roller extending in a second direction perpendicular to the first direction. The flexible screen assembly is wound around the roller so that the roller can rotate following movement of the flexible screen assembly.

In an embodiment, the first driving device includes a first motor and a push mechanism connected to the first motor. The first motor is configured to drive the push mechanism to move in the first direction, so that the second shell moves along with the push mechanism in the first direction.

In an embodiment, the push mechanism includes a transmission assembly connected to the first motor, and a push assembly connected to the transmission assembly and the second shell. The first motor is configured to drive the transmission assembly to move, so that the push mechanism moves along with the transmission assembly and drives the second shell to move in the first direction.

In an embodiment, the push assembly includes a first base provided at the first shell, and a push rod slidably connected to the first base and connected to the second shell. A resilient member is sleeved on an outer surface of the push rod.

In an embodiment, the transmission assembly includes a second base provided at the first shell, a transmission screw rotatably connected to the second base and connected to the first motor, and a connecting member sleeved on the transmission screw and connected to one end of the push rod. The first motor is configured to drive the transmission screw to rotate, so as to drive the connecting member and the push rod to move in the first direction.

In an embodiment, the connecting member is provided with a first through-hole. The first through-hole is provided on its inner wall with a transmission thread. The transmission thread engages with threaded teeth of the transmission screw, so that rotation of the transmission screw can drive the connecting member to move linearly in the first direction.

In an embodiment, the transmission assembly further includes a guide rod provided parallel to the transmission screw. The connecting member is further provided with a second through-hole. The guide rod passes through the second through-hole.

In an embodiment, the roller includes a shaft extending in the second direction, a first barrel and a second barrel. The first barrel and the second barrel are spaced on an outer surface of the shaft and are rotatably connected to the shaft. The other end of the push rod is connected to the shaft, and is located at an interval between the first barrel and the second barrel.

In an embodiment, the transmission assembly includes a gear provided on an output shaft of the first motor. The push assembly includes a push rod provided with a plurality of engagement teeth on an outer surface. The push rod engages the gear through the engagement teeth, so that rotation of the gear can drive the push rod to reciprocate in the first direction.

In an embodiment, the second driving device includes a second motor and an attachment belt. One end of the attachment belt is connected to an output shaft of the second motor, and the other end of the attachment belt is connected to the second end of the flexible screen assembly. The second motor is configured to drive the attachment belt to extend, so that part of the flexible screen assembly is unfolded outside the first shell. The second motor is further configured to drive the attachment belt to curl, so that part of the flexible screen assembly is retracted within the first shell.

Provided in another aspect of the present disclosure is a shell assembly configured to retract and unfold a flexible screen assembly, which includes: a first shell connected to a first end of the flexible screen assembly. The first shell includes a carrier plate, a first side and a first rear cover connected together to define an accommodation cavity with an opening. A second shell is movably connected to the first shell. A first driving device is configured to drive the second shell to move relative to the first shell in a first direction, so that the second shell moves outside the accommodation cavity or is accommodated within the accommodation cavity through the opening. A second driving device is coupled to a second end of the flexible screen assembly. The second driving device is configured to drive the flexible screen assembly to move.

In an embodiment, the second shell includes a second side, a third side, a fourth side opposite to the third side, and a roller extending in a second direction perpendicular to the first direction. The second side and the roller are provided between the third side and the fourth side, and the flexible screen assembly is wound around the roller so that the roller can rotate following movement of the flexible screen assembly.

In an embodiment, the first driving device includes a first motor, a transmission assembly connected to the first motor, and a push assembly connected to the transmission assembly and the second shell. The first motor is configured to drive the transmission assembly to move, so that the push mechanism moves along with the transmission assembly and drives the second shell to move in the first direction.

In an embodiment, the second driving device includes a second motor and an attachment belt. One end of the attachment belt is connected to an output shaft of the second motor, and the other end of the attachment belt is connected to the flexible screen assembly. The second motor is configured to drive the attachment belt to extend, so that part of the flexible screen assembly is unfolded outside the first shell. The second motor is further configured to drive the attachment belt to curl, so that part of the flexible screen assembly is retracted within the first shell.

Provided in a further aspect of the present disclosure is an electronic device, which includes: a first shell; a second shell movably connected to the first shell; a driving device; and a flexible screen assembly. A first end of the flexible screen assembly is connected to the first shell, and a second end of the flexible screen assembly is coupled to the driving device. The driving device includes a motor, a transmission assembly connected to the motor, and a push assembly connected to the transmission assembly and the second shell. The motor is configured to drive the transmission assembly to move, so that the push mechanism moves along with the transmission assembly, driving the second shell to move in a first direction relative to the first shell, and driving the flexible screen assembly to move.

In an embodiment, the push assembly includes a push rod provided with a rotating shaft. The rotating shaft extends in a second direction perpendicular to the first direction. The flexible screen assembly is slidably connected to the rotating shaft via an attachment belt wound around the rotating shaft. One end of the attachment belt is fixedly connected to the first shell, and the other end of the attachment belt is connected to the second end of the flexible screen assembly.

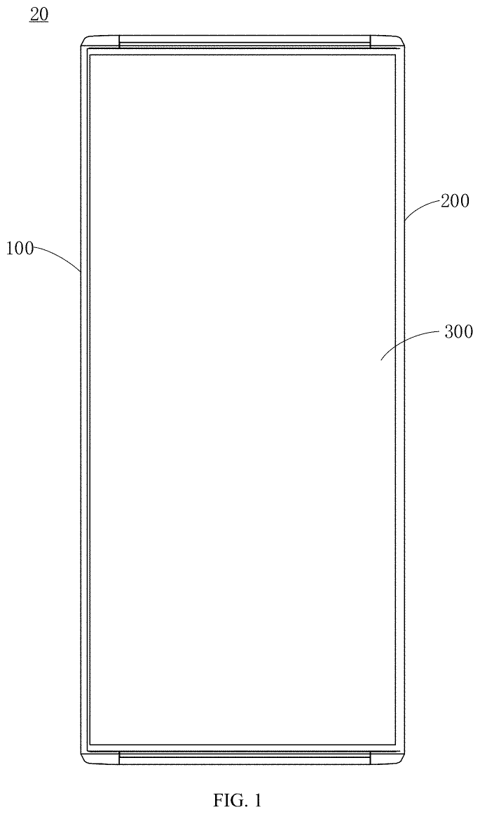

Referring to FIG. 1, which is a first schematic structural diagram of the electronic device provided in the embodiments of the present disclosure, the electronic device 20 shown in FIG. 1 may be a computing device, such as a laptop computer, a computer monitor containing an embedded computer, a tablet computer, a cellular telephone, a media player, or other hand-held or portable electronic devices, a smaller device (such as a wristwatch device, a hanging device, a headphone or earpiece device, a device embedded into eyeglasses or other devices worn on the head of a user, or other wearable or miniature devices), a television, a computer monitor containing no embedded computer, a gaming device, a navigation device, an embedded system (such as a system in which electronic devices having displays are installed in a kiosk or an automobile), a device performing the functions of two or more of such devices, or other electronic devices. In the example shown in FIG. 1, the electronic device 20 is a portable device, such as a cellular phone, a media player, a tablet computer, or other portable computing devices. Other configurations may be used for the electronic device 20, if desired. The example of FIG. 1 is only exemplary.

As shown in FIG. 1, the electronic device 20 may include a first shell 100 and a second shell 200. The first shell 100 and the second shell 200 are movably connected with each other, such that a distance between the first shell 100 and the second shell 200 is adjustable. The first shell 100 and the second shell 200 are provided side by side in a first direction. The first shell 100 and the second shell 200 may be formed of plastic, glass, ceramic, fiber composite, metal (e.g., stainless steel, aluminum, or the like), other suitable materials, or a combination of any two or more of such materials. The first shell 100 and the second shell 200 may be formed in a one-piece configuration, in which some or all of the first shell 100 and the second shell 200 are machined or molded into a single structure, or may be formed of a plurality of structures (e.g., an inner frame structure, one or more structures forming the outer shell surface, etc.). In this case, the structure and fabrication materials of the first shell 100 and the second shell 200 may be the same or different.

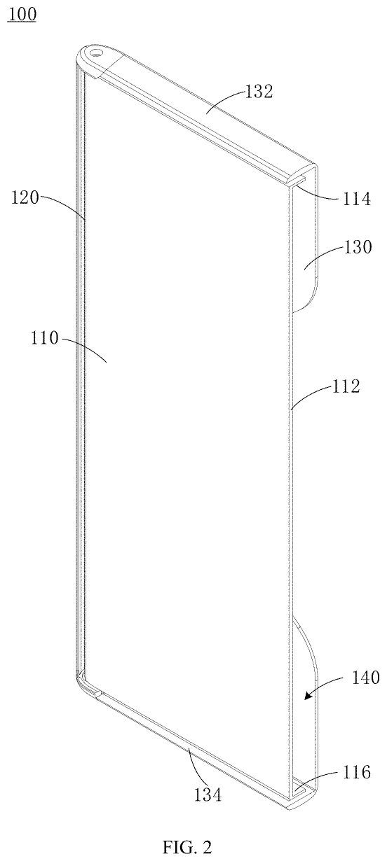

Referring to FIG. 2, which is a schematic structural diagram of the first shell 100 in the electronic device 20 shown in FIG. 1, the first shell 100 may include a carrier plate 110, a first side 120, and a first rear cover 130, where the first side 120 is provided on a circumference of the carrier plate 110. The carrier plate 110 can be used to carry internal components of the electronic device 20, such as a flexible screen assembly, a driving device, a circuit board, etc. The first side 120 can be used to form a bezel of the electronic device 20 to protect internal components of the electronic device 20. The carrier plate 110, the first side 120 and the first rear cover 130 are connected together to define an accommodation cavity 140 including an opening to accommodate components of the electronic device 20, such as batteries, a driving device, etc. The opening may provide access for the second shell 200 to enter and exit the accommodation cavity 140. The second shell 200 may move outside the accommodation cavity 140 through the opening, and may also move into the accommodation cavity 140 through the opening, so that the second shell 200 can be accommodated within the accommodation cavity 140.

The carrier plate 110 includes a body part 112, and a plurality of side parts which are located at edge positions of the body part 112. Among them, the body part 112 may be of a regular shape, such as a rectangular structure, and the carrier plate 110 may include a first side part 114 and a second side part 116 provided opposite to each other in a second direction perpendicular to the first direction.

One end of the first side 120 is connected to the first side part 114, and the other end of the first side 120 is connected to the second side part 116. The first side 120 is provided between the first side part 114 and the second side part 116, and two ends of the first side 120 can be formed by bending along the first side part 114 and the second side part 116, respectively. In an embodiment, the first side 120 has a first end part and a second end part opposite to each other. The first end part can be bent in a direction parallel to the first side part 114 and can cover the outer surface of the first side part 114. The second end part can be bent in a direction parallel to the second side part 116 and can cover the outer surface of the second side part 116. It is to be noted that two ends of the first side 120 may also be flush with outer surfaces of the first side part 114 and the second side part 116.

The first rear cover 130 can be sleeved outside the carrier plate 110 so as to hide internal components provided on the carrier plate 110, so that the user cannot observe the components inside the electronic device 20 from outside the electronic device 20. It is understood that part of the flexible screen assembly 300, and the first rear cover 130 can be provided on two opposite sides of the carrier plate 110, and part of the flexible screen assembly 300 may be provided on a display side of the carrier plate 110 to display images.

The flexible screen assembly 300 may include a flexible display module and a flexible support. The flexible support is located on a non-display side of the flexible display module for supporting the flexible display module. It is understood that the flexible support can possess a high structural strength, which on the one hand can support the flexible display module and improve flatness of the flexible display module, so that the flexible display module is not easily collapsed or wrinkled during a displaying process, and on the other hand, the flexible support can also improve an overall strength of the flexible screen assembly 300, which can protect the flexible screen assembly 300 from damage during an extending process. Among them, the flexible display module can be an OLED (Organic Light Emitting Diode) module, which may include a display substrate and packaging material with an organic light emitting material encapsulated there-between. The OLED module includes a number of OLED units, and each OLED unit is electrically connected to a main board of the electronic device for self-illumination and displaying images. The flexible display module can also be a LCD (Liquid Crystal Display Liquid Crystal Display) module, which may include a display substrate and packaging material with a liquid crystal material encapsulated there-between. The main board of the electronic device provides voltage for the liquid crystal material so as to change the arrangement direction of liquid crystal molecules. Light projected from a backlight passes through the LCD module and forms images in the display area to display images.

The first rear cover 130 may include a first bent part 132 and a second bent part 134 opposite to each other. The first bent part 132 can be located on the outer surface of the first side part 114, and the outer surface of the first bent part 132 can be flush with one end surface of the first side 120. The second bent part 134 can be located on the outer surface of the second side part 116, and the outer surface of the second bent part 134 can be flush with the other end surface of the first side 120, so that a gap between the first rear cover 130 and the first side 120 cannot be observed from outside, which not only can play a waterproof and dustproof role, but also can maintain the consistency of appearance.

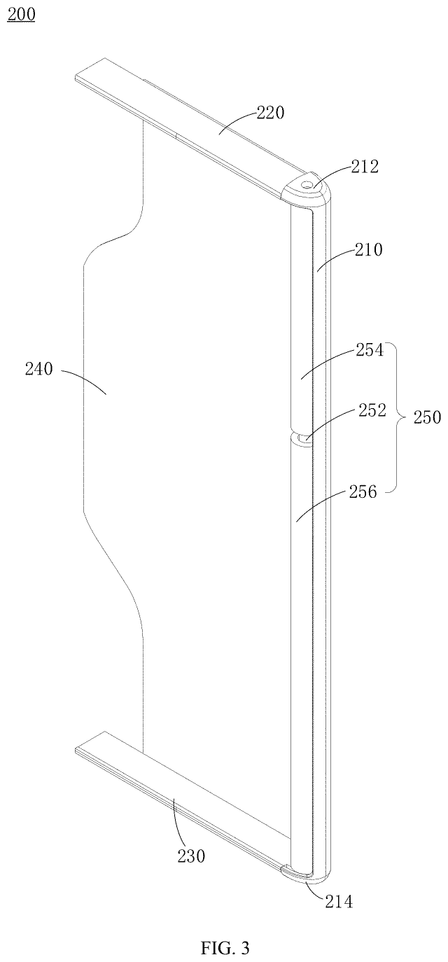

As shown in FIG. 3, which is a schematic structural diagram of the second shell 200 in the electronic device 20 shown in FIG. 1, the second shell 200 may include a second side 210, a third side 220, and a fourth side 230. The second side 210 is provided opposite to the first side 120 in the first direction, and the second side 210 is provided between the third side 220 and the fourth side 230. Two ends of the second side 210 are formed by bending along the third side 220 and the fourth side 230, respectively. In an embodiment, the second side 210 has a third end 212, and a fourth end 214 opposite to each other. The third end 212 is bent in a direction parallel to the third side 220 and covers the outer surface of the third side 220, and the fourth end 214 is bent in a direction parallel to the fourth side 230 and covers the outer surface of the fourth side 230. It is noted that two end surfaces of the second side 210 may also be flush with the outer surfaces of the third side 220 and the fourth side 230.

When the second shell 200 is received in the accommodation cavity 140, the third end 212 of the second side 210 can abut against the first bent part 132 of the first rear cover 130, and the fourth end 214 of the second side 210 can abut against the second bent part 134 of the first rear cover 130, such that the first side 120, the second side 210, the third side 220, and the fourth side 230 define a complete bezel structure, to protect components inside the electronic device 20 from damage. In some embodiments, the outer surface of the second side 210 is flush with the outer surface of the first end part 242, and the outer surface of the third side 220 is flush with the outer surface of the second end part 244, such that a gap between the first side 120 and the second side 210 and the third side 220 cannot be observed from outside the electronic device 20, maintaining a consistent appearance of the electronic device 20.

The third side 220 and the fourth side 230 are provided opposite to each other in a second direction perpendicular to the first direction, and the third side 220 is movably connected to the first side part 114, so that the third side 220 can move in a direction parallel to the first side part 114. The fourth side 230 is movably connected to the second side part 116, so that the fourth side 230 can move in a direction parallel to the second side part 116, which in turn allows the second shell 200 to move outside the accommodation cavity 140, or to move into the accommodation cavity 140.

The second shell 200 further includes a roller 250, which is provided between the third side 220 and the fourth side 230, and which extends in a second direction perpendicular to the first direction. The flexible screen assembly 300 is wound around the roller 250 and is movably connected to the roller, so that the roller 250 can rotate following movement of the flexible screen assembly 300. The roller 250 includes a rotating shaft 252 extending in the second direction, and one or more barrels such as a first barrel 254 and a second barrel 256. One end of the shaft 252 is connected to the third side 220 and the other end of the shaft 252 is connected to the fourth side 230. The first barrel 254 and the second barrel 256 are spaced at a distance so that part of the shaft 252 is exposed. The first barrel 254 and the second barrel 256 are rotatably connected to the shaft 252 (e.g., by ball connection), such that the first barrel 254 and the second barrel 256 can rotate about the shaft 252.

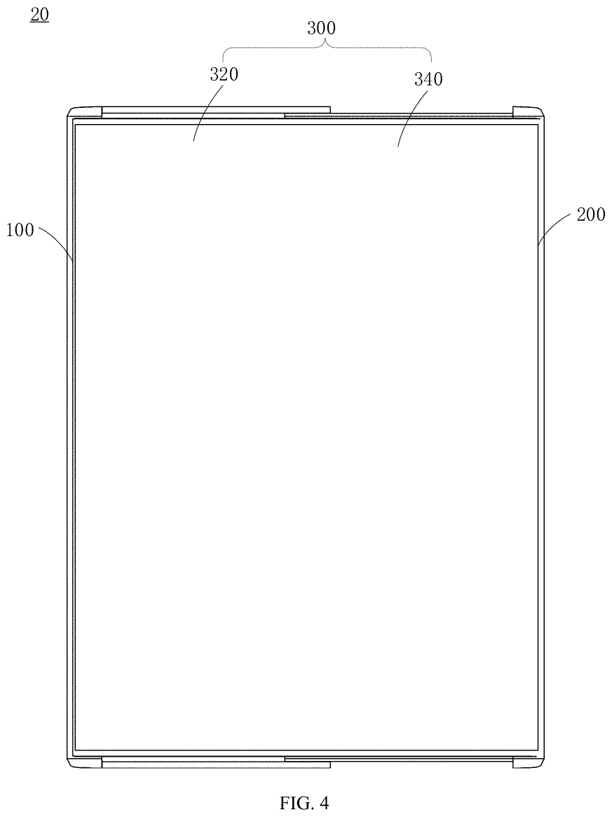

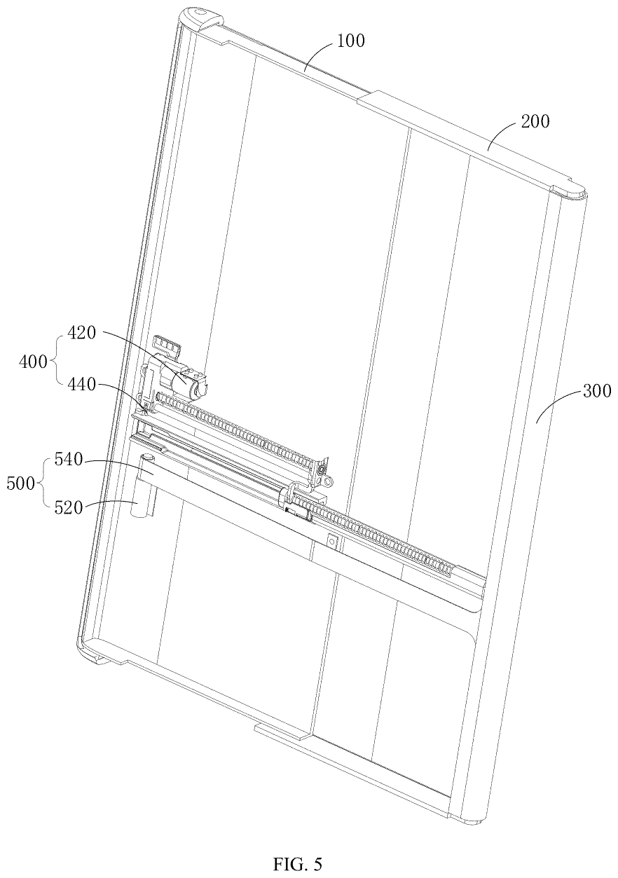

Reference is made to FIG. 4 which is a second schematic structural diagram of the electronic device 20 provided in the embodiments of the present disclosure, and FIG. 5 which is a third schematic structural diagram of the electronic device 20 provided in the embodiments of the present disclosure. Another part of the flexible screen assembly 300 may be wound around the first barrel 254 and the second barrel 256, and slide along outer surfaces of the first barrel 254 and the second barrel 256. This arrangement can reduce friction between the flexible screen assembly 300 and the first barrel 254, and friction between the flexible screen assembly 300 and the second barrel 256, allowing the flexible screen assembly 300 to move more smoothly. Furthermore, sliding of the flexible screen assembly 300 can also drive the first barrel 254 and the second barrel 256 to rotate, and rotation of the first barrel 254 and the second barrel 256 can drive the second shell 200 to move, thereby increasing the speed of the second shell 200 moving towards or away from the first shell 100.

Notably, the shaft 252 may not be provided with one or more barrels on the outside, such as by winding the flexible screen assembly 300 directly on the outer surface of the shaft 252, so that the flexible screen assembly 300 may slide along the outer surface of the shaft 252.

As shown in FIG. 5, the electronic device 20 may further include a first driving device 400. The first driving device 400 may be provided on the first shell 100. For example, the first driving device 400 may be provided on the carrier plate 110. Alternatively, the first driving device 400 may be provided on the second shell 200. For example, the first driving device 400 may be provided on the second side 210, third side 220 and/or fourth side 230 of the second shell 200. Alternatively, the second shell 200 may be provided with a substrate, and the first driving device 400 may be provided on the substrate.

The first driving device 400 is configured to drive the second shell 200 to move relative to the first shell 100, to either mate or separate the first shell 100 and the second shell 200. Accordingly, the electronic device is able to vary between an extended state where the second shell 200 is furthest away from the first shell 100, and a retracted state where the second shell 200 is closest to the first shell 100. In an embodiment, the first shell 100 may be stationary, and the first driving device 400 may drive the second shell 200 to move in a direction away from the first shell 100, such that the second shell 200 protrudes from the accommodation cavity 140 to achieve separation of the first shell 100 from the second shell 200. The first driving device 400 may also drive the second shell 200 to move in a direction towards the first shell 100, such that the second shell 200 enters the accommodation cavity 140 and is received within the accommodation cavity 140, so as to mate the first shell 100 with the second shell 200. It is understood that the first shell 100 and the second shell 200 can reciprocate in a direction parallel to the first shell 100 or parallel to the second shell 200, that is, in a first direction where the first shell 100 and the second shell 200 are provided side by side, thereby separating or mating the first shell 100 and the second shell 200.

Alternatively, in the above embodiment, the second shell 200 may be stationary, and the first driving device 400 can drive the second shell 200 to reciprocate in a direction parallel to the first shell 100. Alternatively, the first driving device 400 can also drive the first shell 100 and the second shell 200 to move simultaneously, so as to either mate or separate the first shell 100 and the second shell 200.

Still referring to FIG. 3, the second shell 200 may further include a second rear cover 240. The second rear cover 240 can be provided over the second side 210, the third side 220, and the fourth side 230, so as to cover components provided on the second shell 200. It is understood that the second display 340 of the flexible screen assembly 300 is provided on one side of the second side 210, the third side 220 and the fourth side 230, and the second rear cover 240 is provided on the other side of the second side 210, the third side 220 and the fourth side 230. The second display 340 of the flexible screen assembly 300 can display image(s) together with the first display 320 provided on the first shell 100. It should be noted that the first display 320 provided on the first shell 100 can also display images alone.

Referring to FIGS. 4 and 5, the first driving device 400 may include a first motor 420, and a push mechanism 440 connected to the first motor 420. The first motor 420 is configured to drive the push mechanism 440 to push the second shell 200 to reciprocate in the first direction, causing the second shell 200 to extend outside or enter the accommodation cavity 140, so as to either mate or separate the second shell 200 and the first shell 100.

The push mechanism 440 may include a transmission assembly 442, and a push assembly 444. The transmission assembly 442 is connected to the first motor 420. One end of the push assembly 444 is connected to the transmission assembly 442, and the other end of the push assembly 444 is connected to the second shell 200. The first motor 420 is configured to drive the transmission assembly 442 to move, such that the push assembly 444 connected thereto moves along with the transmission assembly 442, which in turn makes the push assembly 444 move in a direction parallel to the first shell 100, that is, in a first direction where the first shell 100 and the second shell 200 are provided side by side. The transmission assembly 442 may be any of a screw transmission assembly, a gear set or a telescoping assembly, or a combination thereof, where the telescoping assembly may include an electric actuator, an electro-hydraulic actuator, a pneumatic actuator, or a hydraulic actuator, etc.

The push assembly 444 may include a first base 4441, and a push rod 4442, where the first base 4441 is fixed to the carrier plate 110, the first base 4441 is provided with a slideway, and the push rod 4442 is disposed in the slideway and is slidably connected to the slideway, so that the push rod 4442 can slide within the slideway. One end of the push rod 4442 is connected to the transmission assembly 442, and the other end of the push rod 4442 is connected to the second shell 200; for example, the push rod 4442 may be connected to the shaft 252.

When the electronic device 20 is about to control the first shell 100 to move relative to the second shell 200, the first motor 420 can be controlled to drive the transmission assembly 442 to move. The transmission assembly 442 can drive the push rod 4442 to slide within the slideway in the first direction, which in turn drives the second shell 200 to move in the first direction. In this way, the first shell 100 and the second shell 200 can either be separated or mated. When one of the first shell 100 and the second shell 200 are drawn out from the other one, the first shell 100 and the second shell 200 cooperatively defines an expanded state of the electronic device 20. When one of the first shell 100 and the second shell 200 are retracted to the other one, the first shell 100 and the second shell 200 cooperatively define an retracted state of the electronic device 20.

In an embodiment, the electronic device 20 can control an output shaft of the first motor 420 to rotate clockwise (or counterclockwise), so that the transmission assembly 442 connected with the output shaft of the first motor 420 moves along with the output shaft of the first motor 420. The transmission assembly 442 can drive the push rod 4442 to move in a direction away from the first shell 100, and the second shell 200 connected to the push rod 4442 moves along with the push rod 4442, so that the second shell 200 also moves in a direction away from the first shell 100, which in turn can cause the second shell 200 to extend from the accommodation cavity 140 to separate the second shell 200 from the first shell 100. In another embodiment, the electronic device 20 can control an output shaft of the first motor 420 to rotate clockwise (or counterclockwise), so that the transmission assembly 442 connected with the output shaft of the first motor 420 moves along with the output shaft of the first motor 420. The transmission assembly 442 can drive the push rod 4442 to move in a direction towards the first shell 100, and the second shell 200 connected to the push rod 4442 moves along with the push rod 4442, so that the second shell 200 also moves in a direction towards the first shell 100, which in turn makes the second shell 200 retract from outside of the accommodation cavity 140 into the accommodation cavity 140, thereby mating the second shell 200 with the first shell 100.

The outer surface of the push rod 4442 may be provided with a resilient member 4443, which may be a spring or other resilient member. The resilient member 4443 can be used to support and protect the push rod 4442. For example, when the electronic device 20 falls, the resilient member 4443 can function as a cushion so as to reduce an instantaneous impact on the push rod 4442. This in turn can reduce an impact on the transmission assembly 442 connected with the push rod 4442, thereby protecting the transmission assembly 442 from damage.

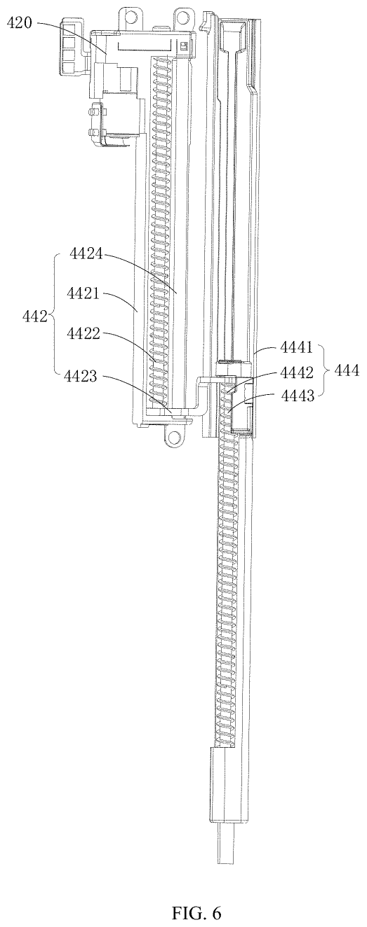

As shown in FIG. 6, which is a schematic structural diagram of the first transmission assembly in the electronic device shown in FIG. 5, the transmission assembly 442 may include a second base 4421, a transmission screw 4422, and a connecting member 4423. The second base 4421 can be fixed to the first shell 100. For example, the second base 4421 may be fixed to the carrier plate 110. The transmission screw 4422 is rotatably connected to the second base 4421. For example, the transmission screw 4422 may be connected to a bearing embedded in the second base 4421, thereby enabling the transmission screw 4422 to rotate relative to the second base 4421. The transmission screw 4422 is also connected to the first motor 420, which is configured to drive the transmission screw 4422 to rotate relative to the second base 4421. The connecting member 4423 is sleeved on the transmission screw 4422 and is connected to the transmission screw 4422 in a transmittable way. The connecting member 4423 is also connected to the push rod 4442. The connecting member 4423 is driven by the transmission screw 4422 to reciprocate in an axial direction perpendicular to the transmission screw 4422, which in turn drives the push rod 4442 to reciprocate in the first direction. When the push rod 4442 is reciprocating, the second shell 200 follows the push rod 4442 in reciprocating motion.

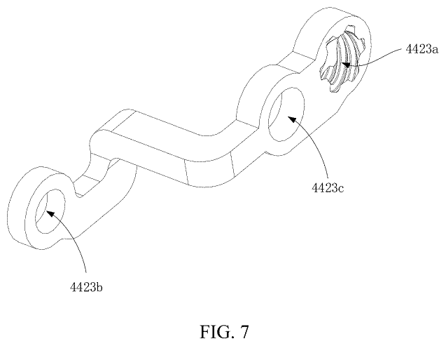

Reference is made to FIG. 7, which is a schematic structural diagram of the connecting member in the first driving device shown in FIG. 6. The transmission assembly 442 may further include a guide rod 4424, which is provided on the second base 4421. For example, two ends of the guide rod 4424 may be directly inserted and fixed in the connection holes of the second base 4421. Among them, the guide rod 4424 and the transmission screw 4422 are set parallel to each other, and the connecting member 4423 can be sleeved on both the transmission screw 4422 and the guide rod 4424. The guide rod 4424 can guide and position the connecting member 4423. In an embodiment, the connecting member 4423 can be provided with a first through-hole 4423a, a second through-hole 4423b and a third through-hole 4423c. The connecting member 4423 is sleeved on the transmission screw 4422 through the first through-hole 4423a, sleeved on the push rod 4442 through the second through-hole 4423b, and sleeved on the guide rod 4424 through the third through-hole 4423c, and is in sliding contact with the guide rod. The first through-hole 4423a is provided with a transmission thread on its inner wall, which engages with the threaded teeth of the transmission screw 4422, such that rotation of the transmission screw 4422 drives the connecting member 4423 to move linearly in the first direction via the first through-hole 4423a. Rotation of the transmission screw 4422 can be transformed to linear movement of the connecting member 4423.

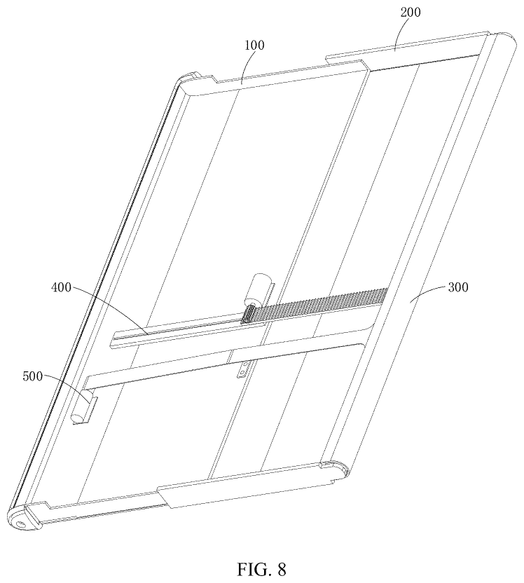

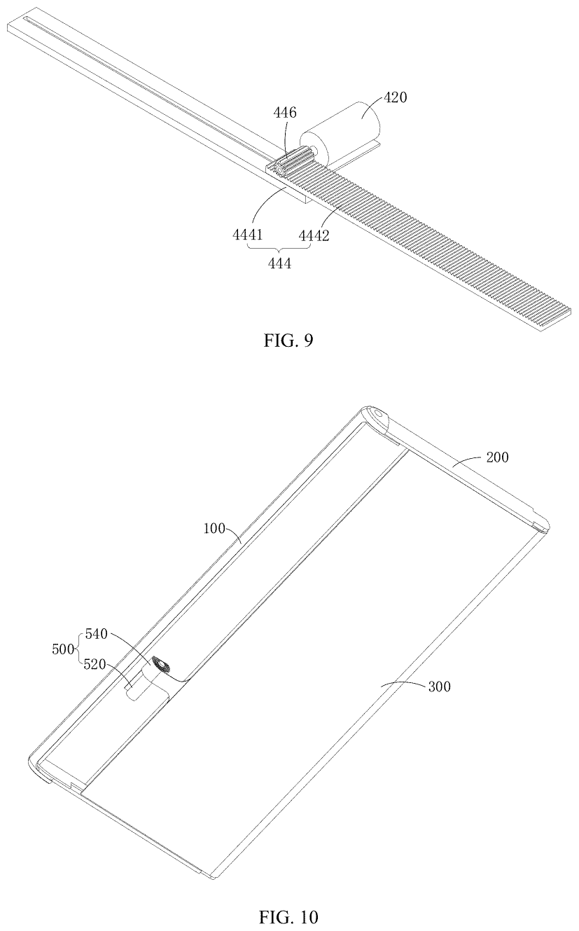

Reference is made to FIG. 8 which is a fourth schematic structural diagram of the electronic device provided in the embodiments of the present disclosure, and FIG. 9 which is a schematic structural diagram of the first driving device in the electronic device shown in FIG. 8. The transmission assembly 442 may be a gear set. For example, the transmission assembly 442 includes a gear 446, which is provided on the output shaft of the first motor 420. The first motor 420 may drive the gear 446 to rotate. The push rod 4442 is connected to the gear 446 in a transmittable way. For example, a plurality of engagement teeth can be provided on the outer surface of the push rod 4442, and the push rod 4442 engages the gear 446 through the engagement teeth, so that rotation of the gear 446 can drive the push rod 4442 to reciprocate in the first direction. It should be noted that the transmission assembly 442 may include a plurality of gears, and the reciprocating motion of the push rod 4442 can be driven by the mutual transmission of the plurality of gears.

Reference is made to FIG. 10, which shows a fifth schematic structural diagram of the electronic device 20 provided in the embodiments of the present disclosure. The electronic device 20 may further include a second driving device 500 connected to the flexible screen assembly 300. The second driving device 500 may be configured to drive the flexible screen assembly 300 to move, so as to retract part of the flexible screen assembly 300 within the first shell 100, or to unfold part of the flexible screen assembly 300 outside the first shell 100, thereby increasing the display area of the electronic device 20.

In an embodiment, the flexible screen assembly 300 may include a first display 320 referring to part of the flexible screen assembly 300 located on the first shell 100, and a second display 340 referring to another part of the flexible screen assembly 300 located on the second shell 200, as shown in FIG. 4. In an initial state, the first display 320 can be exposed outside the first shell 100 (in other words, outside the electronic device 20), and the second display 340 can be received in the accommodation cavity 140, as shown in FIG. 1. When the first driving device 400 drives the second shell 200 to move in a direction away from the first shell 100, the second driving device 500 can drive the flexible screen assembly 300 to move along with the second shell 200 after a predetermined time interval, such that the second display 340 initially received in the accommodation cavity 140 slowly slides along the roller 250 and is gradually unfolded outside the first shell 100 (or outside the electronic device 20), as shown in FIG. 4 and FIG. 5, which in turn makes both the first display 320 and the second display 340 unfolded outside the electronic device 20. The first display 320 and the second display 340 can display one image together or two images separately. Compared to the initial state where only the first display 320 is used for display, unfolding the second display 340 outside the electronic device 20 can increase the display area of the electronic device 20.

The embodiments of the present disclosure makes the display area of the flexible screen assembly 300 selectable, by providing two driving devices to control motion state of the first shell 100, the second shell 200 and the flexible screen assembly 300, respectively. Compared with the displays in the related art with fixed installation space, the embodiments of the present disclosure can increase the display area of the electronic device 20 without additional installation space of the flexible screen assembly 300 (or display screen).

Referring to FIGS. 2 and 10, the second driving device 500 can include a second motor 520, and an attachment belt 540. The second motor 520 is configured to drive the attachment belt 540 to curl or extend, so as to allow another part of the flexible screen assembly 300 to be retracted within the accommodation cavity 140 or to be unfolded outside the first shell 100. For example, one end of the attachment belt 540 is wound on an output shaft of the second motor 520, and the other end of the attachment belt 540 is connected to one end of the flexible screen assembly 300, while the other end of the flexible screen assembly 300 is connected to the first shell 100.

When the electronic device 20 is about to control the flexible screen assembly 300 to be unfolded outside the first shell 100, the electronic device 20 can control the second motor 520 to drive the attachment belt 540 to gradually change from a curled state to an extended state, which in turn allows the second display 340 to slide along an outer surface of the first barrel 254 and an outer surface of the second barrel 256 in a direction away from the second motor 520, so as to gradually unfold the second display 340 originally received in the accommodation cavity 140 to be outside the electronic device 20 (or the first shell 100) and to display the images together with the first display 320 originally exposed outside the electronic device 20.

When the electronic device 20 is about to control the flexible screen assembly 300 to be received within the first shell 100, the electronic device 20 can control the second motor 520 to drive the attachment belt 540 to gradually change from an extended state to a curled state, which in turn allows the flexible screen assembly 300 to slide slowly along an outer surface of the first barrel 254 and an outer surface of the second barrel 256 in a direction towards the second motor 520, so as to gradually retract the second display 340 originally unfolded outside the electronic device 20 (or the first shell 100) to be within the accommodation cavity 140 (or within the first shell 100).

The size of the second display 340 can be smaller than or equal to that of the first shell 100, so that the second display 340 can be fully unfolded without curling, when it is received in the accommodation cavity 140. Compared with curled displays in the related art, the embodiments of the present disclosure can avoid damage due to frequent curling of the flexible screen assembly, thereby extending service life of the flexible screen assembly.

When the first driving device 400 drives the first shell 100 to move relative to the second shell 200, if the second driving device 500 moves synchronously with the first driving device 400, the flexible screen assembly 300 may become loose. This can lead to undesirable phenomena, such as wrinkles or unevenness of the flexible screen assembly 300, which affect the quality of images being displayed on the electronic device 20.

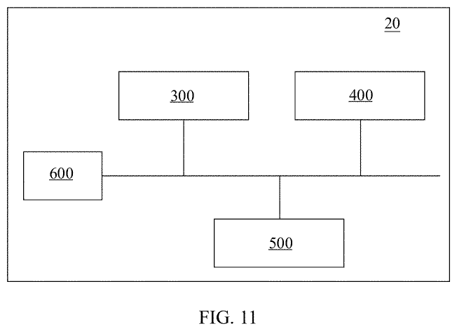

Referring to FIG. 11 which is a sixth schematic structural diagram of the electronic device 20 provided in the embodiments of the present disclosure, a processor 600 of the electronic device 20 can be electrically coupled to the first driving device 400 and second driving device 500, so as to allow for the flexible screen assembly 300 to be always in a taut state and to control tension of the flexible screen assembly 300. The processor 600 may be configured to control, at different timings, the first driving device 400 to drive the first shell 100 and the second shell 200 to move relative to each other, and the second driving device 500 to drive the flexible screen assembly 300 to move, such that the first driving device 400 and the second driving device are driven asynchronously in steps. It is understood that there can be a time interval between drivings of the first driving device 400 and the second driving device 500. The time interval may be very short, for example, to ensure that two ends of the flexible screen assembly 300 remain in a taut state, thereby ensuring tension of the flexible screen assembly 300. This can avoid wrinkles and unevenness or other undesirable phenomena caused by the movement of the flexible screen assembly 300, which may adversely affect images being displayed on the electronic device 20.

In an embodiment, when the second display 340 needs to be unfolded, that is, when when the electronic device changes from the retracted state to the extended state, the processor 600 can control the first driving device 400 to drive the second shell 200 to move in a direction away from the first shell 100 at a first timing T1, so that the second shell 200 extends slowly outside the accommodation cavity 140 to draw the second shell 200 from the first shell 100. At a second timing T2 during movement of the second shell 200, the processor 600 controls the second motor 520 to drive the attachment belt 540 to unfold slowly, such that the second display 340 of the flexible screen assembly 300 can slide along outer surfaces of the first barrel 254 and the second barrel 256 to be outside the accommodation cavity 140, until the electronic device is in the extended state. The first timing T1 is earlier than the second timing T2, such as T2=T1+t1, where t1 is the first preset time interval that can be set according to actual use, which the present disclosure is not limited to. It is understood that when the second display 340 is unfolded, the second shell 200 can move prior to the flexible screen assembly 300, so that the flexible screen assembly 300 may remain in a taut state during gradual unfolding of the second display 340 to be outside the first shell 100.

When the second display 340 needs to be retracted into the accommodation cavity 140, that is, when the electronic device changes from the extended state to the retracted state, the processor 600 can control the second motor 520 at a third timing T3 to drive the attachment belt 540 to curl slowly, and the attachment belt 540 pulls the second display 340 in a direction towards the second motor 520 during the curling process. The second display 340 in moving will cause the first barrel 254 and the second barrel 256 to rotate, which in turn causes the second side 210 to move in a direction towards the first side 120. At a fourth timing T4 during movement of the flexible screen assembly 300, the processor 600 controls the first driving device 400 to drive the second shell 200 to move in a direction away from the first shell 100, making the second shell 200 retract slowly into the accommodation cavity 140, thereby mating the first shell 100 and the second shell 200, until the electronic device is in the retracted state. Among them, the third timing T3 is earlier than the fourth timing T4, such as T4=T3+t2, where t2 is the second preset time interval which can be set according to actual use, which the present disclosure is not limited to. It is understood that where the second display 340 is retracted, the flexible screen assembly 300 moves prior to the second shell 200, such that the flexible screen assembly 300 remains in a taut state during gradual retraction of the second display 340 to be within the first shell 100.

In some other embodiments, the processor 600 may also control the first driving device 400 and the second driving device 500 based on a tension value of the flexible screen assembly 300. In an embodiment, the flexible screen assembly 300 may be provided with a tension sensor, which is configured to detect a tension value of the flexible screen assembly 300. When the second display 340 needs to be unfolded, the processor 600 can first control the first driving device 400 to start, and obtain a first tension value of the flexible screen assembly 300 detected by the tension sensor, and then control the second driving device 500 to start when the first tension value of the flexible screen assembly 300 exceeds a first preset tension value. Similarly, when the second display 340 needs to be retracted, the processor 600 can first control the second driving device 500 to start, and obtain a second tension value of the flexible screen assembly 300 detected by the tension sensor, and then control the first driving device to start when the second tension value of the flexible screen assembly 300 exceeds a second preset tension value. In this embodiment, start-up timings of the first driving device 400 and the second driving device 500 are determined according to a magnitude of the tension value of the flexible screen assembly 300, which can avoid the tension value of the flexible screen assembly 300 being too small due to a small start-up time interval between the two, causing the flexible screen assembly 300 to become wrinkled. It may also avoid the situation where the tension value of the flexible screen assembly 300 is too large due to a large start-up time interval between the two, causing damage to the flexible screen assembly 300. Compared with controlling start-up of two driving devices based on a fixed time interval, more accurate and intelligent control of the flexible screen can be provided in this embodiment.

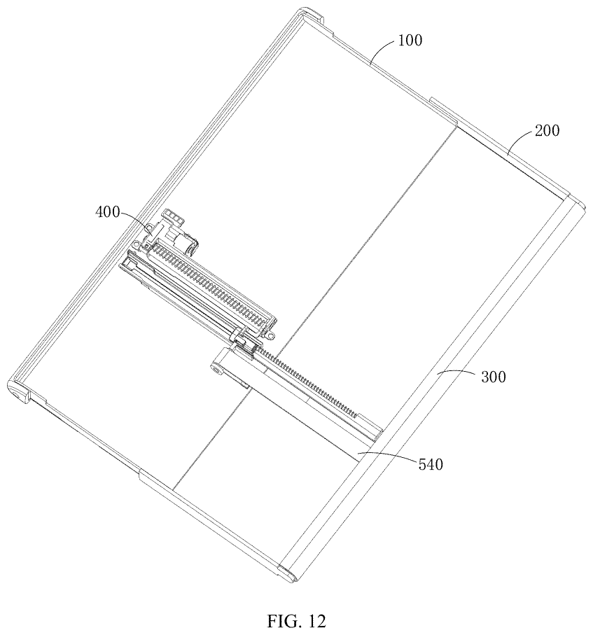

Alternative to the above embodiment, the electronic device 20 can only be provided with the first driving device 400 without the second driving device 500, as shown in FIG. 12, which is a seventh schematic structural diagram of the electronic device provided in the embodiments of the present disclosure. One end of the flexible screen assembly 300 is connected to the first shell 100, and the other end of the flexible screen assembly 300 is connected to the first driving device 400. The first driving device 400 drives the first shell 100 to move relative to the second shell 200, and drives the flexible screen assembly 300 to move, so that the second display 340 of the flexible screen assembly 300 extends outside the accommodation cavity 140 and is unfolded on an outer surface of the second shell 200, thus allowing the second display 340 to display image(s) together with the first display 320.

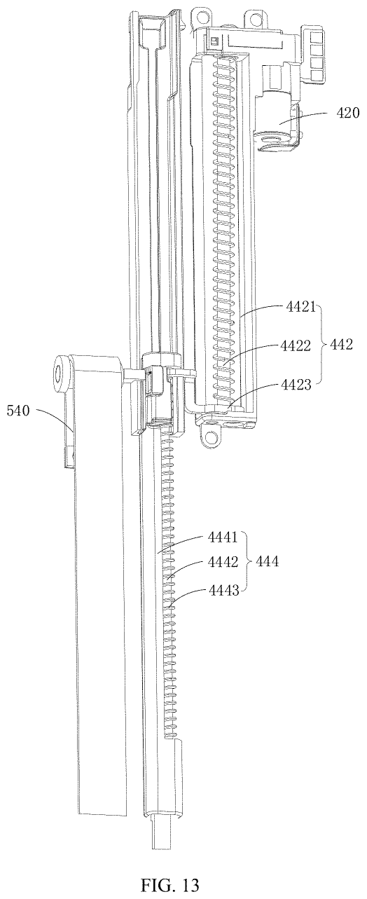

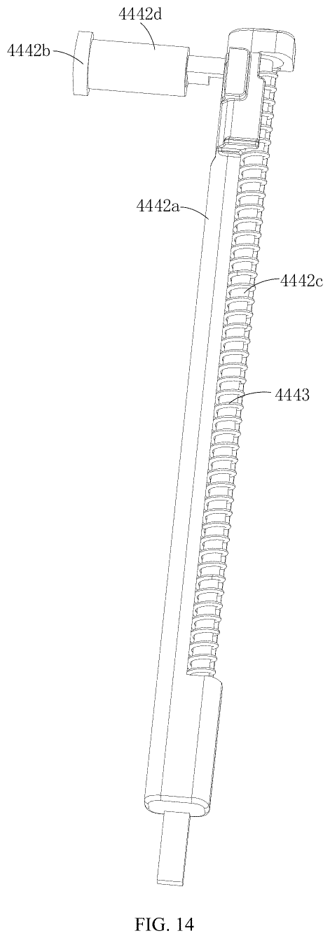

As shown in FIG. 13 which is a schematic structural diagram of the first driving device in the electronic device shown in FIG. 12, and FIG. 14 which is a schematic structural diagram of the push assembly in the first driving device shown in FIG. 12, the push rod 4442 includes a support part 4442a, a rotating shaft 4442b and a push part 4442c. One end of the push part 4442c is fixed to the support part 4442a, and the other end of the push part 4442c is connected to the roller 250 (e.g., connected with the shaft 252). The rotating shaft 4442b is provided at an end of the support part 4442a away from the roller 250. The flexible screen assembly 300 is slidably connected to the rotating shaft 4442b via an attachment belt 540. In an embodiment, the attachment belt 540 is wound around the rotating shaft 4442b, one end of the attachment belt 540 is fixedly connected to the first shell 100, and the other end of the attachment belt 540 is connected to the other end of the flexible screen assembly 300.

When the second display 340 needs to be unfolded, the processor 600 can control the first motor 420 to drive the transmission assembly 442 to move, and the transmission assembly 442 drives the push assembly 444 to move in a direction away from the first shell 100. The push assembly 444 pushes the second shell 200 to move as well in a direction away from the first shell 100 through the push part 4442c. Meanwhile, since the rotating shaft 4442b also moves in a direction away from the first shell 100, the attachment belt 540 also moves along with the rotating shaft 4442b in a direction away from the first shell 100 and slides along the outer surface of the rotating shaft 4442b, a length of the attachment belt 540 located on the second shell 200 is increased. Under joint action of the second shell 200 and the attachment belt 540, the second display 340 slides along the rollers 250 toward outer surface of the second shell 200 to be outside the accommodation cavity 140, making the second display 340 exposed outside the electronic device 20. It is understood that when the flexible screen assembly 300 receives a pushing force applied thereto by the second shell 200, the attachment belt 540 will gradually reduce a pulling force thereof on the flexible screen assembly 300, thereby allowing the second display 340 of the flexible screen assembly 300 to be unfolded.

When the second display 340 needs to be retracted, the processor 600 can control the first motor 420 to drive the transmission assembly 442 to move, and the transmission assembly 442 drives the push assembly 444 to move in a direction towards the first shell 100. The push assembly 444 pulls the second shell 200 to move as well in a direction towards the first shell 100 through the push part 4442c. Meanwhile, since the rotating shaft 4442b also moves in a direction towards the first shell 100, the attachment belt 540 also follows the rotating shaft 4442b to slide along the outer surface of the rotating shaft 4442b towards the first shell 100, a length of the attachment belt 540 on the second shell 200 is reduced. Under joint action of the second shell 200 and the attachment belt 540, the second display 340 slides along the roller 250 towards the inner surface of the second shell 200 to be within the accommodation cavity 140, so that the second display 340 is retracted into the accommodation cavity 140. It is understood that when the second shell 200 moves towards the first shell 100, the pushing force exerted by the second shell 200 on the flexible screen assembly 300 will gradually decrease, and at this time, when the attachment belt 540 approaches, the first shell will pull the flexible screen assembly 300 in a direction towards the first shell 100, thereby allowing the second display 340 of the flexible screen assembly 300 to be retracted into the accommodation cavity 140.

It is noted that the second display 340 of the flexible screen assembly 300 remains taut under joint action of the second shell 200 and the attachment belt 540, during the process of the second display 340 of the flexible screen assembly 300 being unfolded outside the first shell 100 or retracted into the first shell 100, to avoid adverse effects on images being displayed on the electronic device 20.

In order to avoid excessive friction between the attachment belt 540 and the rotating shaft 4442b, which can result in excessive tension exerted by the attachment belt 540 on the flexible screen assembly 300 that, in turn, leads to excessive tension damage to the flexible screen assembly 300, the outer surface of the rotating shaft 4442b in this embodiment is also provided with a third barrel 4442d. The third barrel 4442d is rotatably connected to the rotating shaft 4442b, so that the third barrel 4442d can rotate about the rotating shaft 4442b, which in turn allows the attachment belt 540 to drive the third barrel 4442d to rotate. This can further reduce the friction between the attachment belt 540 and the third barrel 4442d, thereby making the attachment belt 540 move more smoothly. It may also avoid the attachment belt 540 from exerting too much tension on the flexible screen assembly 300, which can cause damage to the flexible screen assembly 300. Moreover, the third barrel 4442d may also form a joint rolling mechanism together with the roller 250, thus ensuring smooth retraction and smooth unfolding of the flexible screen assembly 300.

It is understood that the first motor 420 in the present disclosure can provide an active driving effect, while the rollers 250 and the rotating shaft on the second shell 200 are linkage mechanisms and undergo linkage movement under active driving of the first motor 420, so that a motion stroke of the push part 4442c, an unfolding length of the second display 340 and a motion stroke of the attachment belt 540 are equal to each other. This can ensure that the flexible screen assembly 300 remains in a taut state in the unfolding process and retraction process (providing for tension of the flexible screen assembly 300 to be within a certain range), so as to avoid adverse situations, e.g., too much tension of the flexible screen assembly 300 causing damage or too small tension of the flexible screen assembly 300 causing wrinkles due to asynchronous unfolding.

In the present embodiment, relative motion of the first shell 100 and the second shell 200 as well as unfolding and retraction of the flexible screen assembly 300 can be realized by the first driving device 400 only, which can reduce one driving device as compared with the above embodiment and can simplify structure of the electronic device 20 on the basis of the above embodiment.

A detailed description of the shell assembly and the electronic device provided in the embodiments of the present disclosure is set forth above. In this document, specific examples are presented to illustrate the principle and implementation of the present disclosure, but the above description of embodiments is only used to help understand the present disclosure. Meanwhile, for those skilled in the field, the specific implementation and the application scenario are subject to change based on the idea of the present disclosure. In a word, the content of this specification should not be construed as limiting the present disclosure.

What is claimed is:

1. An electronic device, comprising:
a first shell;
a second shell movably connected to the first shell;
a driving mechanism configured to drive the second shell to move relative to the first shell to enable the electronic device to vary between an extended state and a retracted state; and
a flexible screen assembly, comprising a first end connected to the first shell and a second end coupled to the driving mechanism;
wherein, the driving mechanism is further configured to drive the flexible screen assembly to move when the electronic device changes from the extended state to the retracted state.

2. The electronic device according to claim 1, wherein the driving mechanism comprises a first driving device and a second driving device, the first driving device being configured to drive the second shell to move relative to the first shell along a first direction, the second driving device being configured to drive the flexible screen assembly to move.

3. The electronic device according to claim 2, further comprising a processor coupled to the first driving device and the second driving device, wherein the processor is configured to control the first driving device at a first timing to drive the second shell to move away from the first shell, and control the second driving device at a second timing to drive the flexible screen assembly to move, when the electronic device changes from the retracted state to the extended state, so that part of the flexible screen assembly is unfolded outside the first shell;
wherein the first timing is earlier than the second timing.

4. The electronic device according to claim 3, wherein the processor is further configured to control the second driving device at a third timing to drive the flexible screen assembly to move, and to control the first driving device at a fourth timing to drive the second shell to move towards the first shell, when the electronic device changes from the extended state to the retracted state, so that part of the flexible screen assembly is retracted within the first shell, wherein the third timing is earlier than the fourth timing.

5. The electronic device according to claim 2, wherein the first driving device and the second driving device are provided on the first shell;
wherein the second shell comprises a roller extending in a second direction perpendicular to the first direction, and the flexible screen assembly is wound around the roller so that the roller can rotate following movement of the flexible screen assembly.

6. The electronic device according to claim 2, wherein the first driving device comprises a first motor and a push mechanism connected to the first motor;
wherein the first motor is configured to drive the push mechanism to move in the first direction, such that the second shell moves along with the push mechanism in the first direction.

7. The electronic device according to claim 6, wherein the push mechanism comprises a transmission assembly connected to the first motor, and a push assembly connected to the transmission assembly and the second shell;
wherein the first motor is configured to drive the transmission assembly to move, so that the push mechanism moves along with the transmission assembly and drives the second shell to move in the first direction.

8. The electronic device according to claim 7, wherein the push assembly comprises a first base provided at the first shell, and a push rod slidably connected to the first base and connected to the second shell;
wherein a resilient member is sleeved on an outer surface of the push rod.

9. The electronic device according to claim 8, wherein the transmission assembly comprises a second base provided at the first shell, a transmission screw rotatably connected to the second base and connected to the first motor, and a connecting member sleeved on the transmission screw and connected to one end of the push rod;
wherein the first motor is configured to drive the transmission screw to rotate, so as to drive the connecting member and the push rod to move in the first direction.

10. The electronic device according to claim 9, wherein the connecting member is provided with a first through-hole; the first through-hole is provided on an inner wall with a transmission thread;
wherein the transmission thread engages with threaded teeth of the transmission screw, so that rotation of the transmission screw can drive the connecting member to move linearly in the first direction.

11. The electronic device according to claim 9, wherein the transmission assembly further comprises a guide rod provided parallel to the transmission screw;
wherein the connecting member is further provided with a second through-hole, the guide rod passing through the second through-hole.

12. The electronic device according to claim 5, wherein the roller comprises a shaft extending in the second direction, a first barrel and a second barrel;
wherein the first barrel and the second barrel are spaced on an outer surface of the shaft and are rotatably connected to the shaft;
wherein another end of a push rod is connected to the shaft, and is located at an interval between the first barrel and the second barrel.

13. The electronic device according to claim 7, wherein the transmission assembly comprises a gear provided on an output shaft of the first motor; the push assembly comprises a push rod provided with a plurality of engagement teeth on an outer surface;
wherein the push rod engages the gear through the engagement teeth, so that rotation of the gear can drive the push rod to reciprocate in the first direction.

14. The electronic device according to claim 2, wherein the second driving device comprises a second motor and an attachment belt;
wherein one end of the attachment belt is connected to an output shaft of the second motor, and another end of the attachment belt is connected to the second end of the flexible screen assembly;
wherein the second motor is configured to drive the attachment belt to extend so that part of the flexible screen assembly is unfolded outside the first shell; the second motor is further configured to drive the attachment belt to curl so that part of the flexible screen assembly is retracted within the first shell.

15. A shell assembly adapted to retraction and unfolding of a flexible screen assembly, comprising:
a first shell connected to a first end of the flexible screen assembly, the first shell comprising a carrier plate, a first side and a first rear cover connected together to define an accommodation cavity with an opening;
a second shell movably connected to the first shell;
a first driving device configured to drive the first second shell to move relative to the second first shell in a first direction, so that the second shell moves outside the accommodation cavity or is accommodated within the accommodation cavity through the opening; and
a second driving device coupled to a second end of the flexible screen assembly, the second driving device being configured to drive the flexible screen assembly to move.

16. The shell assembly according to claim 15, wherein the second shell comprises a second side, a third side, a fourth side opposite to the third side, and a roller extending in a second direction perpendicular to the first direction;
wherein the second side and the roller are provided between the third side and the fourth side, and the flexible screen assembly is wound around the roller, so that the roller can rotate following movement of the flexible screen assembly.

17. The shell assembly according to claim 15, wherein the first driving device comprises a first motor, a transmission assembly connected to the first motor, and a push assembly connected to the transmission assembly and the second shell;
wherein the first motor is configured to drive the transmission assembly to move so that a push mechanism moves along with the transmission assembly and drives the second shell to move in the first direction.

18. The shell assembly according to claim 15, wherein the second driving device comprises a second motor and an attachment belt; one end of the attachment belt is connected to an output shaft of the second motor, and another end of the attachment belt is connected to the flexible screen assembly;
wherein the second motor is configured to drive the attachment belt to extend so that part of the flexible screen assembly is unfolded outside the first shell; the second motor is further configured to drive the attachment belt to curl so that part of the flexible screen assembly is retracted within the first shell.

19. An electronic device, comprising:
a first shell;
a second shell movably connected to the first shell;
a driving device; and
a flexible screen assembly, a first end of the flexible screen assembly being connected to the first shell, a second end of the flexible screen assembly being coupled to the driving device;
wherein the driving device comprises a motor, a transmission assembly connected to the motor, and a push assembly connected to the transmission assembly and the second shell;
wherein the motor is configured to drive the transmission assembly to move, so that a push mechanism moves along with the transmission assembly, driving the second shell to move in a first direction relative to the first shell, and driving the flexible screen assembly to move.

20. The electronic device according to claim 19, wherein the push assembly comprises a push rod provided with a rotating shaft, the rotating shaft extending in a second direction perpendicular to the first direction;
wherein the flexible screen assembly is slidably connected to the rotating shaft via an attachment belt wound around the rotating shaft;
wherein one end of the attachment belt is fixedly connected to the first shell, and another end of the attachment belt is connected to the second end of the flexible screen assembly.
